(19) United States
(12) Patent Application Publication
(10) Pub. No.: US 2009/0133091 A1
(43) Pub. Date: May 21, 2009

(54) WIRELESS COMMUNICATIONS DEVICE AND INTEGRATED CIRCUITS WITH DIGITAL TELEVISION RECEIVER AND METHODS FOR USE THEREWITH

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/942,741

(22) Filed: Nov. 20, 2007

(51) Int. Cl. H04N 7/173

(52) U.S. Cl. 725/133

(57) ABSTRACT

An integrated circuit includes a digital television receiver section that receives a digital television signal. A wireless telephone transceiver section generates an outbound RF signal from an outbound symbol stream and converts an inbound RF signal into an inbound symbol stream. A processing module converts outbound data into the outbound symbol stream and converts the inbound symbol stream into inbound data. The digital television receiver and the wireless telephone receive section can share at least one common receiver component. An optional GPS receiver can also share at least one common receiver component and can generate GPS data that can be used when executing a digital television application.

### CROSS-REFERENCE TO RELATED APPLICATIONS

Not applicable

### BACKGROUND OF THE INVENTION

1. Technical Field of the Invention

This invention relates generally to mobile communication devices, digital television receivers and more particularly to RF integrated circuit for use therein.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to an antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

While transmitters generally include a data modulation stage, one or more IF stages, and a power amplifier, the particular implementation of these elements is dependent upon the data modulation scheme of the standard being supported by the transceiver. For example, if the baseband modulation scheme is Gaussian Minimum Shift Keying (GMSK), the data modulation stage functions to convert digital words into quadrature modulation symbols, which have a constant amplitude and varying phases. The IF stage includes a phase locked loop (PLL) that generates an oscillation at a desired RF frequency, which is modulated based on the varying phases produced by the data modulation stage. The phase modulated RF signal is then amplified by the power amplifier in accordance with a transmit power level setting to produce a phase modulated RF signal.

As another example, if the data modulation scheme is 8-PSK (phase shift keying), the data modulation stage functions to convert digital words into symbols having varying amplitudes and varying phases. The IF stage includes a phase locked loop (PLL) that generates an oscillation at a desired RF frequency, which is modulated based on the varying phases produced by the data modulation stage. The phase modulated RF signal is then amplified by the power amplifier in accordance with the varying amplitudes to produce a phase and amplitude modulated RF signal.

As yet another example, if the data modulation scheme is x-QAM (16, 64, 128, 256 quadrature amplitude modulation), the data modulation stage functions to convert digital words into Cartesian coordinate symbols (e.g., having an in-phase signal component and a quadrature signal component). The IF stage includes mixers that mix the in-phase signal component with an in-phase local oscillation and mix the quadrature signal component with a quadrature local oscillation to produce two mixed signals. The mixed signals are summed together and filtered to produce an RF signal that is subsequently amplified by a power amplifier.

As is also known, hand held global positioning system (GPS) receivers are becoming popular. In general, GPS receivers include receiver-processors, and a highly-stable clock, and an antenna that is tuned to the frequencies transmitted by the satellites. The receiver may also include a display for providing location and speed information to the user. Many GPS receivers can relay position data to a PC or other device using a US-based National Marine Electronics Association (NMEA) protocol.

Technical specifications have been created for transmitting digital television receivers to portable devices such as the digital video broadcasting-handheld (DVB-H), digital video broadcasting-satellite handheld (DVB-SH) and digital media broadcasting (DMB).

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a communication system in accordance with the present invention.

FIG. 2 is a schematic block diagram of an embodiment of another communication system in accordance with the present invention.

FIG. 3 presents a pictorial representation of a wireless network 109 in accordance with an embodiment of the present invention.

FIG. 4 is a schematic block diagram of an embodiment of a communication device 10 in accordance with the present invention.

FIG. 5 is a schematic block diagram of a communication device 30 in accordance with another embodiment of the present invention.

FIG. 6 is a schematic block diagram of a communication device 30′ in accordance with another embodiment of the present invention.

FIG. 7 is a schematic block diagram of an embodiment of RF transceiver 135 and digital television receiver 187 in accordance with the present invention.

FIG. 8 is a schematic block diagram of an embodiment of GPS receiver 210 in accordance with the present invention.

FIG. 9 is a schematic block diagram of an embodiment of an RF front end 340 in accordance with the present invention.

FIG. 10 is a pictorial representation of screen display 300 in accordance with an embodiment of the present invention.

FIG. 11 is a flow chart of an embodiment of a method in accordance with the present invention.

### DETAILED DESCRIPTION OF THE INVENTION

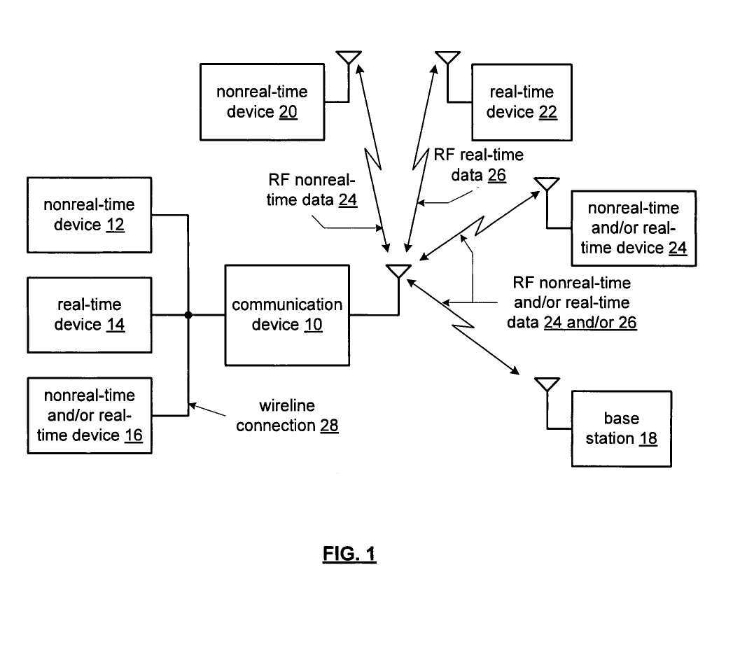

FIG. 1 is a schematic block diagram of an embodiment of a communication system in accordance with the present invention. In particular a communication system is shown that includes a communication device 10 that communicates real-time data 24 and non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary and receive digital television (DTV) data such as Digital Broadcast Video-Handheld (DVB-H), Digital Broadcast Video-Satellite Handheld (DVB-SH), Digital Media Broadcasting (DMB), and position data such as Global Positioning System (GPS) data. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, game device, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, IP television, digital television, navigation, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

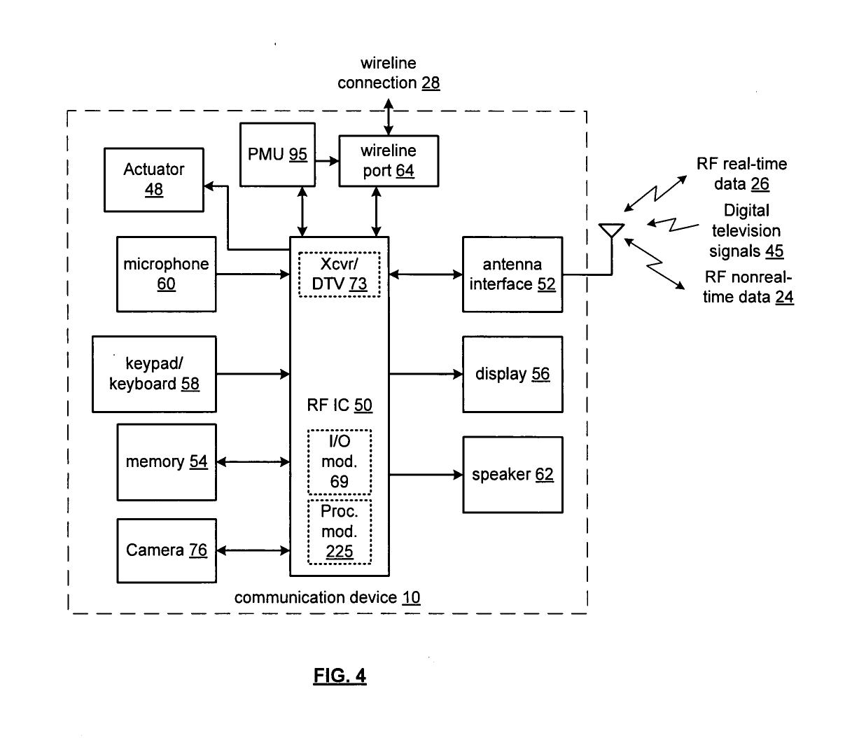

In an embodiment of the present invention, the communication device 10 includes an integrated circuit, such as an RF integrated circuit that includes one or more features or functions of the present invention. Such integrated circuits shall be described in greater detail in association with FIGS. 4-11 that follow.

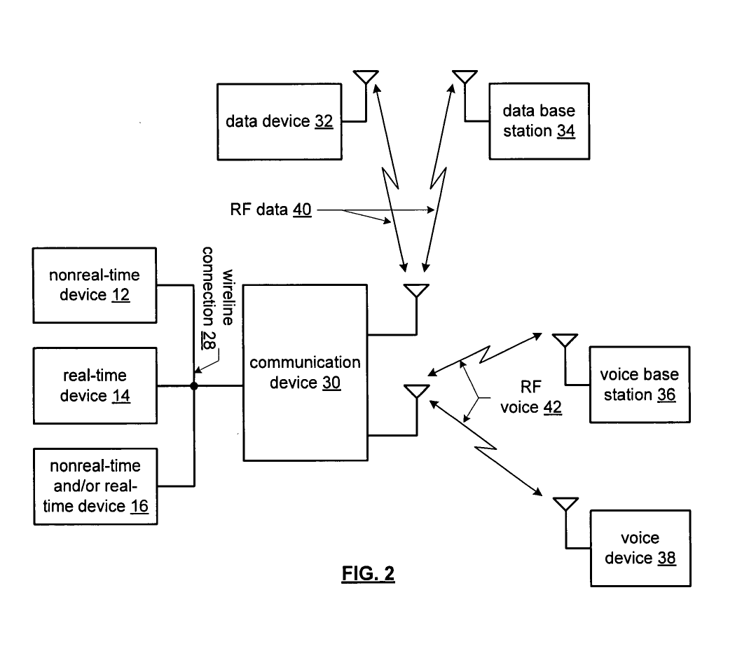

FIG. 2 is a schematic block diagram of an embodiment of another communication system in accordance with the present invention. In particular, FIG. 2 presents a communication system that includes many similar elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes one or more separate wireless transceivers for communicating, contemporaneously, via two or more wireless communication protocols with data device 32 and/or data base station 34 via RF data 40 and voice base station 36 and/or voice device 38 via RF voice signals 42.

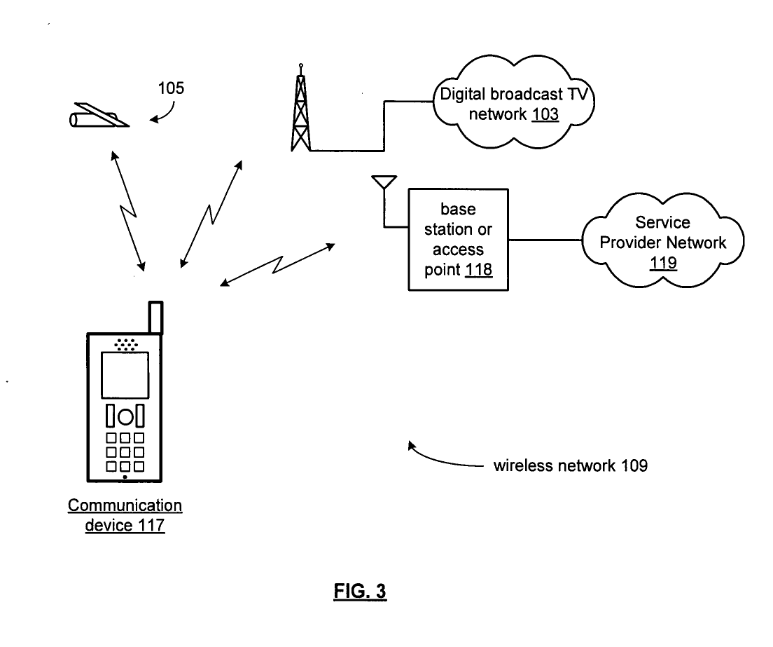

FIG. 3 presents a pictorial representation of a wireless network 109 in accordance with an embodiment of the present invention. In particular, communication device 117 is a wireless telephone device or other device that includes a wireless telephone transceiver and that is capable of placing and receiving conventional wireless telephone calls, placing and receiving voice over internet protocol telephone calls, otherwise communicating via a cellular voice or data protocol such as GSM, GPRS, AMPS, UMTS, EDGE or other wireless telephony protocol that can be used to communicate with a service provider network 119, such as a wireless telephone or data network, via base station or access point 118. In addition, communication device 117 receives digital television signals from a digital broadcast television network 103.

In an embodiment of the present invention, communication device 117 includes a GPS receiver that receives GPS signals, such as signals from a plurality of satellites such as satellite 105, and generates position data that is used by communication device 117 and/or service provider network 119 for location-based services, for placing emergency calls such as 911 (e911) calls. In addition, the position data can be used by communication device 117 in a video application for viewing video programming received via the digital broadcast television network 103. For instance, the video application can include an electronic program guide (EPG), and a position sensitive channel line-up that stores information, received as EPG data via either digital broadcast television network 103 or via service provider network 119. The EPG data includes information relating to the particular channels available in a plurality of locations, and optionally, that can be correlated via the EPG to the programming available on those channels.

In an embodiment of the present invention, the communication device 117 includes an integrated circuit that will be discussed in conjunction with FIGS. 4-11 that follow.

FIG. 4 is a schematic block diagram of an embodiment of an integrated circuit in accordance with the present invention. In particular, an RF integrated circuit (IC) 50 is shown that implements communication device 10, such as communication device 117 in conjunction with microphone 60, keypad/keyboard 58, memory 54, speaker 62, display 56, camera 76, antenna interface 52 and wireline port 64. In operation, RF IC 50 includes a dual telephony transceiver/digital TV receiver 73 that shares at least one common receiver component such an RF front-end, and/or baseband module for receiving and processing digital television (DTV) signals 45 and further for transmitting and receiving data RF real-time data 26 and non-real-time data 24 via an antenna interface 52 and antenna such as fixed antenna a single-input single-output (SISO) antenna, a multi-input multi-output (MIMO) antenna, a diversity antenna system, an antenna array or other antenna configuration that allows the beam shape, gain, polarization or other antenna parameters to be controlled. In addition, RF IC 50 includes input/output module 69 that includes the appropriate interfaces, drivers, encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Power management circuit (PMU) 95 includes one or more DC-DC converters, voltage regulators, current regulators or other power supplies for supplying the RF IC 50 and optionally the other components of communication device 10 and/or its peripheral devices with supply voltages and or currents (collectively power supply signals) that may be required to power these devices. Power management circuit 95 can operate from one or more batteries, line power, an inductive power received from a remote device, a piezoelectric source that generates power in response to motion of the integrated circuit and/or from other power sources, not shown. In particular, power management module can selectively supply power supply signals of different voltages, currents or current limits or with adjustable voltages, currents or current limits in response to power mode signals received from the RF IC 50. While shown as an off-chip module, PMU 95 can alternatively implemented as an on-chip circuit.

In operation, the dual telephony transceiver/digital TV receiver 73 generates an outbound RF signal from outbound data and generates inbound data from an inbound RF signal that can include wireless telephony data from cellular data and voice applications as well as DTV data and EPG data.

In an embodiment of the present invention, the RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

In further operation, the RF IC 50 executes operational instructions that implement one or more of the applications (real-time or non-real-time) attributed to communication devices 10 and 117 as discussed above and in conjunction with FIGS. 1-3 including the video application that operates based on the digital television data recovered from digital television signals 45.

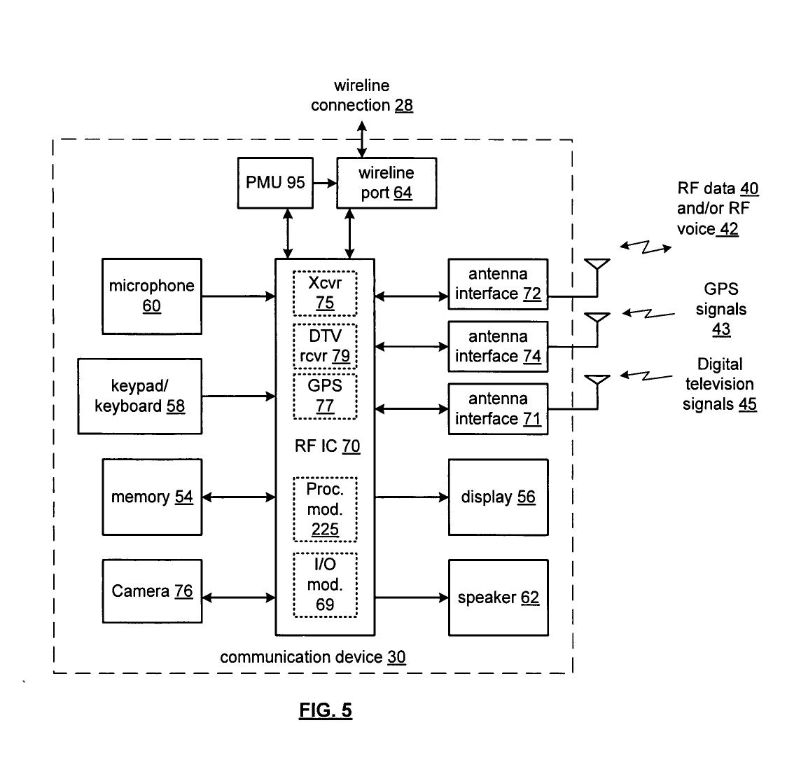

FIG. 5 is a schematic block diagram of another embodiment of an integrated circuit in accordance with the present invention. In particular, FIG. 5 presents a communication device 30 that includes many common elements of FIG. 4 that are referred to by common reference numerals. RF IC 70 is similar to RF IC 50 and is capable of any of the applications, functions and features attributed to RF IC 50 as discussed in conjunction with FIG. 3. However, RF IC 70 includes a separate wireless transceiver 75 for transmitting and receiving RF data 40 and RF voice signals 42 and further a separate GPS receiver 77 for receiving GPS signals 43 via antenna interface 74 and a separate DTV receiver 75 for receiving digital television signals 45 via antenna interface 71.

As discussed in conjunction with FIG. 3, the communication device 30, such as a station set in communication with an access point, wireless telephone set places and receives wireless calls through a wireless telephone network and/or a IP telephone system, via a base station, access point or other communication portal and receives DTV data 45 that can be used in one or more video application. In addition, communication device 30 generates GPS position data via the GPS receiver 77 that can be used for a separate GPS application such as a navigational application, and further the GPS position data can be used in a video application for setting the channel line-up or program schedule based on the position of the communication device 30. In addition, position information generated by GPS receiver 77 can be used to determine a time zone, and can be included in the outbound RF signal sent to a telephone network to support a 911 call such as an E911 emergency call.

In operation, the RF IC 70 executes operational instructions that implement one or more of the applications (real-time or non-real-time) attributed to communication devices 10, 30 and 117 as discussed above and in conjunction with FIGS. 1-4 including the video application that operates based on the digital television data recovered from digital television signals 45.

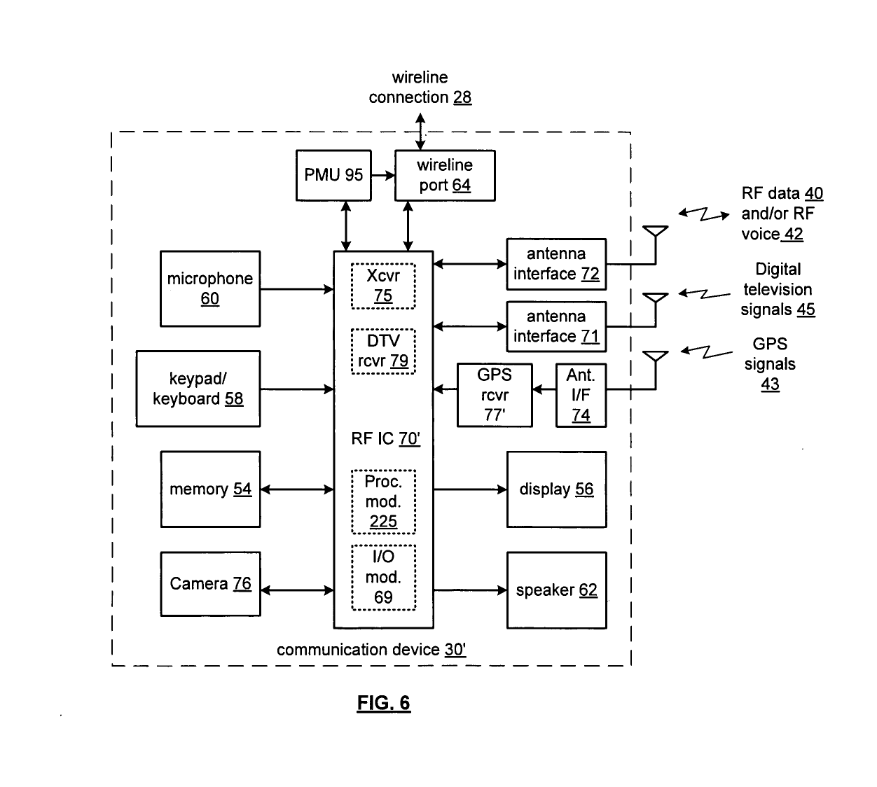

FIG. 6 is a schematic block diagram of another embodiment of an integrated circuit in accordance with the present invention. In particular, FIG. 6 presents a communication device 30 that includes many common elements of FIG. 5 that are referred to by common reference numerals. RF IC 70′ is similar to RF IC 70 and is capable of any of the applications, functions and features attributed to RF ICs 50 and 70 as discussed in conjunction with FIGS. 4-5. However, RF IC 70′ operates in conjunction with an off-chip GPS receiver 77′ for receiving GPS signals 43.

In operation, the RF IC 70′ executes operational instructions that implement one or more of the applications (real-time or non-real-time) attributed to communication devices 10, 30 and 117 as discussed above and in conjunction with FIGS. 1-4 including the video application that operates based on the digital television data recovered from digital television signals 45.

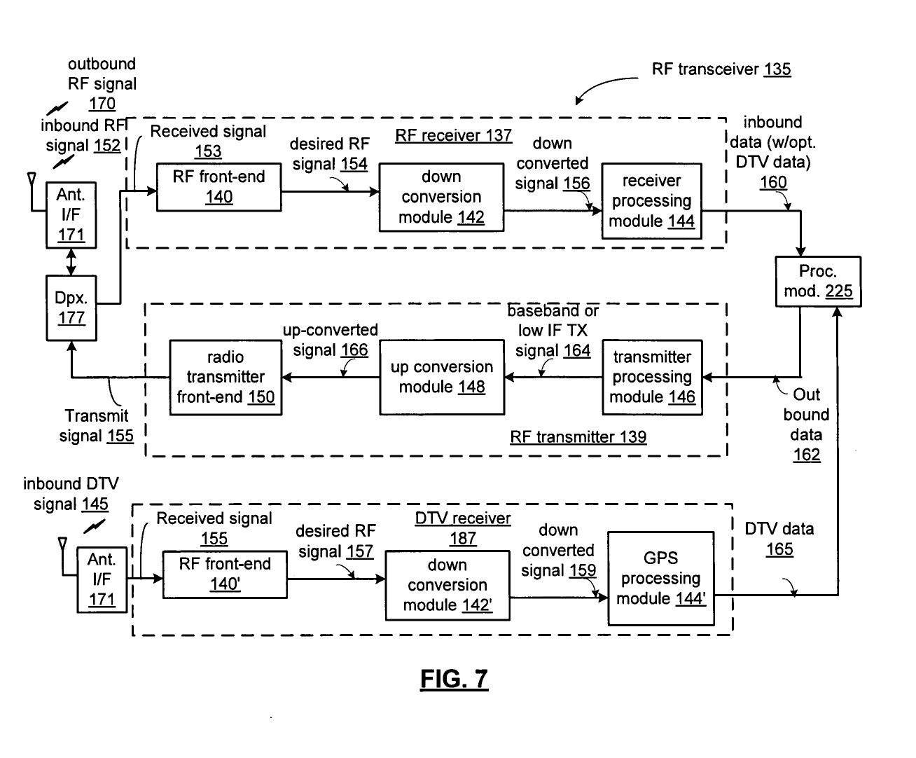

FIG. 7 is a schematic block diagram of an embodiment of RF transceiver 135 and DTV receiver 187 in accordance with the present invention. The RF transceiver 135, such as transceiver 75 includes an RF transmitter 139, and an RF receiver 137. The RF receiver 137 includes a RF front end 140, a down conversion module 142 and a receiver processing module 144. The RF transmitter 139 includes a transmitter processing module 146, an up conversion module 148, and a radio transmitter front-end 150.

As shown, the receiver and transmitter are each coupled to an antenna through an off-chip antenna interface 171 and a diplexer (duplexer) 177 that function as antenna interface 72, that couples the transmit signal 155 to the antenna to produce outbound RF signal 170 and couples inbound signal 152 to produce received signal 153. Alternatively, a transmit/receive switch can be used in place of diplexer 177. While a single antenna is represented, the receiver and transmitter may share a multiple antenna structure that includes two or more antennas. In another embodiment, the receiver and transmitter may share a multiple input multiple output (MIMO) antenna structure, diversity antenna structure, phased array or other controllable antenna structure that includes a plurality of antennas. Each of these antennas may be fixed, programmable, and antenna array or other antenna configuration. Also, the antenna structure of the wireless transceiver may depend on the particular standard(s) to which the wireless transceiver is compliant and the applications thereof.

In operation, the transmitter receives outbound data 162 that includes non-realtime data or real-time data from a host device, such as communication device 10 or other source via the transmitter processing module 146. The transmitter processing module 146 processes the outbound data 162 in accordance with a particular wireless communication standard that can include a cellular data or voice protocol, a WLAN protocol, piconet protocol or other wireless protocol such as IEEE 802.11, Bluetooth, RFID, GSM, CDMA, et cetera) to produce baseband or low intermediate frequency (IF) transmit (TX) signals 164 that includes an outbound symbol stream that contains outbound data 162. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 can include, but is not limited to, scrambling, encoding, puncturing, mapping, modulation, and/or digital baseband to IF conversion.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up-converted signals 166 based on a transmitter local oscillation.

The radio transmitter front end 150 includes a power amplifier and may also include a transmit filter module. The power amplifier amplifies the up-converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration.

The receiver receives inbound RF signals 152 via the antenna and off-chip antenna interface 171 that operates to process the inbound RF signal 152 into received signal 153 for the receiver front-end 140. In general, antenna interface 171 provides impedance matching of antenna to the RF front-end 140, optional bandpass filtration of the inbound RF signal 152 and optionally controls the configuration of the antenna in response to one or more control signals 141 generated by processing module 225.

The down conversion module 142 includes a mixing section, an analog to digital conversion (ADC) module, and may also include a filtering and/or gain module. The mixing section converts the desired RF signal 154 into a down converted signal 156 that is based on a receiver local oscillation, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156 that includes a inbound symbol stream. Note that the ordering of the ADC module and filtering and/or gain module may be switched, such that the filtering and/or gain module is an analog module.

The receiver processing module 144 processes the baseband or low IF signal 156 in accordance with a particular wireless communication standard that can include a cellular data or voice protocol, a WLAN protocol, piconet protocol or other wireless protocol such as IEEE 802.11, Bluetooth, RFID, GSM, CDMA, et cetera) to produce inbound data 160 that can include non-realtime data, realtime data an control data. The processing performed by the receiver processing module 144 can include, but is not limited to, digital intermediate frequency to baseband conversion, demodulation, demapping, depuncturing, decoding, and/or descrambling.

Digital television receiver 187 includes RF front-end 140′, down conversion module 142′ and DTV processing module 144′ that receive the digital television signal 45 and operate in a similar fashion to RF front-end 140, down conversion module 142 and receiver processing module 144, except to process the DTV signal 45 into digital television data 165 for use in a digital television application of a communication device, such as communication device 10, 30, 30′ or 117. While RF receiver 127 and DTV receiver 187 are shown separately, one or more components of the receiver section of each receiver, such as a low noise amplifier or RF front-end 140/140′ can be implemented with shared or common components as will be discussed in greater detail in conjunction with FIG. 9.

In an embodiment of the present invention, receiver processing module 144, processing module 225 and transmitter processing module 146 can be implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the these processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

While the processing module 144, DTV processing module 144′, transmitter processing module 146, and processing module 225 are shown separately, it should be understood that these elements could be implemented separately, together through the operation of one or more shared processing devices or in combination of separate and shared processing. Further, while DTV data is shown as being received by DTV receiver 187, inbound RF signal 152 can carry the DTV data that is processed by RF receiver 127 to optionally recover the DTV data as port of inbound data 160. For instance, DTV data can be transmitted by a 3G (or greater) wireless network, a wireless local area network or other wireless network via an access point or base station such that is not associated with a dedicated broadcast television network.

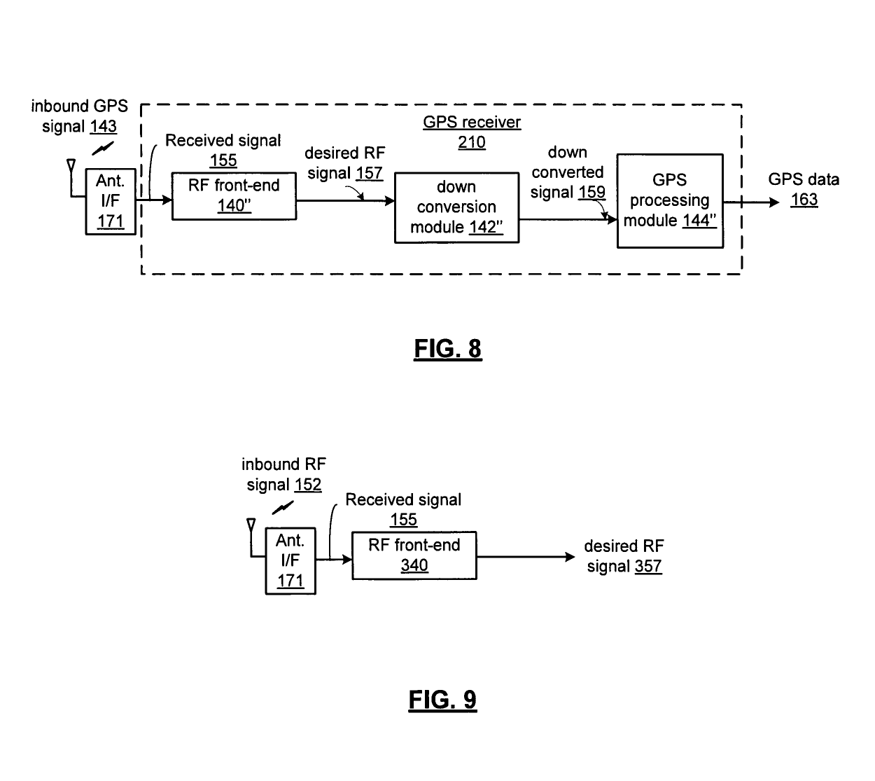

FIG. 8 is a schematic block diagram of an embodiment of GPS receiver 210 in accordance with the present invention. In this embodiment, GPS receiver 210, such as GPS receiver 77 or 77′ generates GPS data 163 that can be used by communication devices 30, 30′ and/or 117 in navigation applications, to provide GPS data to video applications and for other motion or location-based services. In particular, global positioning system (GPS) receiver 210 receives an inbound GPS signal 143, such as GPS signal 43, and generates GPS position data 163 based on the GPS signal. In operation, GPS receiver 210 is coupled to recover a plurality of coarse/acquisition (C/A) signals and a plurality of navigation messages from received GPS signals 43. The GPS receiver 210 utilizes the C/A signals and the navigations messages to determine the position of the communication device.

GPS receiver 210 includes an RF front-end 140″ and down conversion module 142″ that operates in a similar fashion to the modules described in conjunction with RF receiver 137, however, to receive and convert GPS RF signals 143 into a plurality of down converted GPS signals 159. Note that the GPS RF signals 143 may be one or more of: an L1 band at 1575.42 MHz, which includes a mix of navigation messages, coarse-acquisition (C/A) codes, and/or encryption precision P(Y) codes; an L2 band at 1227.60 MHz, which includes P(Y) codes and may also include an L2C code; and/or an L5 band at 1176.45 MHz. Further note that the GPS RF signals 143 can include an RF signal from a plurality of satellites (e.g., up to 20 different GPS satellites RF signals may be received). GPS processing module 144″, that can be implemented in a similar fashion to receiver processing module 144 and DTV processing module 144′ with a shared or separate processing device that operates on the down converted signal 159 to generate GPS data 163, such as GPS position data 212 and/or other GPS data.

In particular, GPS receiver 210 generates one or more clock signals. The clock signal(s) may also be used by the GPS receiver 210 to determine the communication device's position. GPS receiver 210 determines a time delay for at least some of the plurality of C/A signals in accordance with the at least one clock signal. The GPS receiver calculates a distance to a corresponding plurality of satellites of the at least some of the plurality of C/A signals based on the time delays for the at least some of the plurality of C/A signals. In other words, for each GPS signal 43 received, which are received from different satellites, the GPS receiver 210 calculates a time delay with respect to each satellite that the communication device is receiving a GPS RF signal from, or a subset thereof. For instance, the GPS receiver 210 identifies each satellite's signal by its distinct C/A code pattern, then measures the time delay for each satellite. To do this, the receiver produces an identical C/A sequence using the same seed number as the satellite. By lining up the two sequences, the receiver can measure the delay and calculate the distance to the satellite, called the pseudorange. Note that overlapping pseudoranges may be represented as curves, which are modified to yield the probable position.

GPS receiver 210 can calculate the position of the corresponding plurality of satellites based on corresponding navigation messages of the plurality of navigation messages. For example, the GPS receiver 210 uses the orbital position data of the navigation message to calculate the satellite's position. The GPS receiver 210 can determine the location of the RF IC 50, 70 or 70′ (and therefore communication device 30, 30′, 117 or 125) based on the distance of the corresponding plurality of satellites and the position of the corresponding plurality of satellites. For instance, by knowing the position and the distance of a satellite, the GPS receiver 210 can determine it's location to be somewhere on the surface of an imaginary sphere centered on that satellite and whose radius is the distance to it. When four satellites are measured simultaneously, the intersection of the four imaginary spheres reveals the location of the receiver. Often, these spheres will overlap slightly instead of meeting at one point, so the receiver will yield a mathematically most-probable position that can be output as GPS position data 163. In addition, GPS receiver 210 can determine the amount of uncertainty in the calculation.

FIG. 9 is a schematic block diagram of an embodiment of RF front-end 340 in accordance with the present invention. In particular, RF front end 340 operates in a similar fashion to RF front-ends 140, 140′ and 140″ but processes inbound RF signal 152 and received signal 155 that includes RF data or voice signals 40 or 42 in addition to DTV signals 45 and/or GPS signals 43. RF front-end 340 includes a low noise amplifier with sufficient bandwidth, and optionally other filtration and processing to generate desired signal 357 for down conversion by one or more down conversion stages to extract separate baseband signals that represent voice signals 40 or 42 in addition to DTV signals 45 and/or GPS signals 43. In this fashion, a single shared RF front-end 340 can service an RF voice/data receiver such as a wireless telephony receiver, a digital television receiver and/or a GPS receiver.

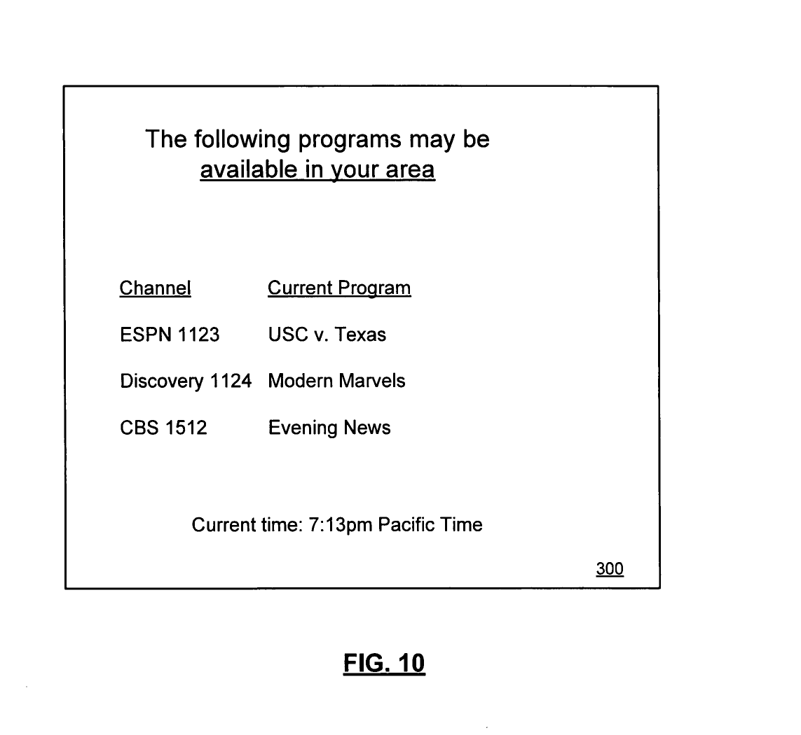

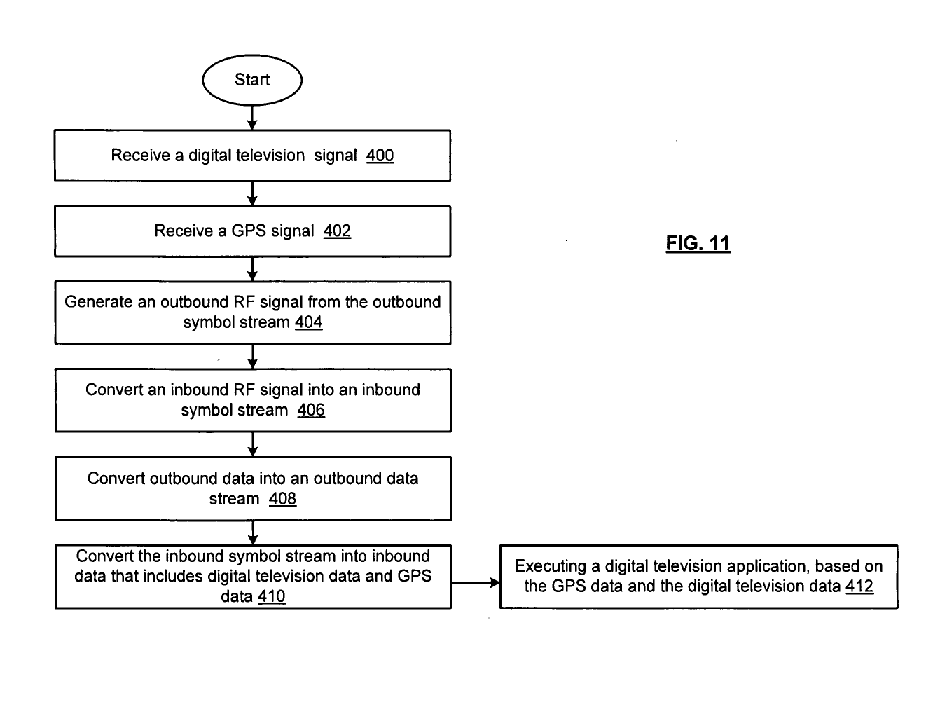

FIG. 10 is a pictorial representation of a screen display 300 in accordance with an embodiment of the present invention. In particular, a screen display is shown that is generated by a video application executed by a communications device such as communications device 30, 30′ or 117 that includes a GPS receiver, such as GPS receiver 77, 77′ or 210. In this embodiment, the digital television application operates based on GPS position data, such as GPS data 163. In particular, the video application includes a digital television application having an electronic program guide (EPG), and a position sensitive channel line-up. The video application stores EPG data relating to the particular channels available in a plurality of locations that can be received as inbound data 152. For example, a user of communication device 30, 30′ or 117 can travel to a different location and, when the video application is executed be advised of channels, current programming and future programming that are available or may be available based on current reception conditions.

In operation, the video application correlates the current position to the channel line-up available in that position and the programming available on those channels. The GPS position data can be transmitted via outbound data to a service provider such as a video service provider associated with digital broadcast television network 103. The EPG data for the particular location indicated by the GPS position data is then received via inbound data in response thereto. In a further embodiment, a broader range of EPG data can be transmitted periodically to communication device 30, 30′ or 117 and stored for later use. For instance, a range of EPG data, such as a week's data can be downloaded and stored to the device along with channel line-ups for different locations or simply changes to channel line-ups. In this fashion, the EPG data can be retrieved from memory when required by the execution of the video application.

Screen 300 provides an example of an indication to the user of the particular channel line-up available in the current position of communication device 30, 30′ or 117, in this case ESPN network (channel 1123), The Discovery Channel (channel 1124) and CBS (channel 1512) and via the EPG, the current programming available on these channels. In a similar fashion other program schedule information such as upcoming or future programming could likewise presented. As shown, the current time is displayed in the correct time zone for the communication device 10, 30, 30′ or 117, that is either based on timing or time zone information received via inbound signal 152, based on timing information generating by the GPS receiver 77, 77′ or 210 or that is generated based on the position of the communication device 30, 30′ or 117 derived from GPS position data, such as GPS data 143.

FIG. 11 is a flow chart of an embodiment of a method in accordance with the present invention. In particular, a method is presented for use in conjunction with one or more of the functions and features described in conjunction with FIGS. 1-10. In step 400, a digital television signal is received. In step 402, a GPS signal is received. In step 404, an outbound RF signal is generated from an outbound symbol stream. In step 406, an inbound RF signal is generated into an inbound symbol stream. In step 408, outbound data is generated into the outbound symbol stream. In step 410, the inbound symbol stream is converted into inbound data that includes digital television data and GPS data. In step 412, a digital television application is executed, based on the GPS position data and the digital television data.

In an embodiment of the present invention, the inbound data, such as inbound data 152, further includes wireless telephony data and EPG data, such as a program schedule data and channel line-up data that is received from a video service provider over a cellular data connection or otherwise via inbound data. The digital television application can determine a particular program schedule and/or a channel line-up for the communication device 30, 30′ or 117, that is based on the GPS position data. The digital television signal includes at least one of, a digital broadcast video handheld signal and a digital media broadcasting signal.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. An integrated circuit comprising:
a digital television receiver section that receives a digital television signal;
a wireless telephone transceiver section coupled to:
generate an outbound RF signal from an outbound symbol stream; and
convert an inbound RF signal into an inbound symbol stream;
a processing module coupled to:
convert outbound data into the outbound symbol stream;
convert the inbound symbol stream into inbound data;
wherein the digital television receiver and the wireless telephone receive section share at least one common receiver component.

2. The integrated circuit of claim 1 wherein the at least one common receiver component includes an RF front-end that receives the inbound RF signal, wherein the inbound RF signals includes the digital television signal and an inbound telephony signal.

3. The integrated circuit of claim 1 wherein the processing module performs baseband processing and the inbound data includes digital television data and wireless telephony data.

4. The integrated circuit of claim 1 further comprising:
a global positioning system (GPS) receiver that receives a GPS signal;
wherein the processing module generates position GPS position data.

5. The integrated circuit of claim 4 wherein the processing module executes a digital television application, based on the GPS position data.

6. The integrated circuit of claim 5 wherein the digital television application determines at least one of, a program schedule, and a channel line-up, based on the GPS position data.

7. The integrated circuit of claim 1 wherein the inbound data includes electronic program guide data.

8. The integrated circuit of claim 1 wherein the processing module converts the outbound data into the outbound symbol stream and converts the inbound symbol stream into the inbound data in accordance with at least one of a cellular data protocol and a cellular voice protocol.

9. The integrated circuit of claim 1 wherein the digital television signal includes at least one of: a digital broadcast video handheld signal and a digital media broadcasting signal.

10. An integrated circuit comprising:
a digital television receiver section that receives a digital television signal;
a global positioning system (GPS) receiver that receives a GPS signal;
a wireless telephone transceiver section coupled to:
generate an outbound RF signal from an outbound symbol stream; and
convert an inbound RF signal into an inbound symbol stream;
a processing module coupled to:
convert outbound data into the outbound symbol stream;
convert the inbound symbol stream into inbound data;
wherein the inbound data includes GPS position data, digital television data and wireless telephony data.

11. The integrated circuit of claim 10 wherein the digital television receiver and the wireless telephone receive section share at least one common receiver component that includes an RF front-end that receives the inbound RF signal, wherein the inbound RF signals includes the digital television signal and an inbound telephony signal.

12. The integrated circuit of claim 10 wherein the processing module executes a digital television application, based on the GPS position data.

13. The integrated circuit of claim 12 wherein the digital television application determines at least one of, a program schedule, and a channel line-up, based on the GPS position data.

14. The integrated circuit of claim 10 wherein the digital television signal includes at least one of: a digital broadcast video handheld signal and a digital media broadcasting signal.

15. The integrated circuit of claim 10 wherein the inbound data includes electronic program guide data.

16. A method comprising
receiving a digital television signal;
receiving a GPS signal;
generating an outbound RF signal from an outbound symbol stream; and
converting an inbound RF signal into an inbound symbol stream;
converting outbound data into the outbound symbol stream;
converting the inbound symbol stream into inbound data that includes digital television data and GPS data; and
executing a digital television application, based on the GPS position data and the digital television data.

17. The method of claim 16 wherein the inbound data further includes and wireless telephony data.

18. The method of claim 16 wherein the inbound data includes electronic program guide (EPG) data.

19. The method of claim 16 wherein the digital television application determines at least one of, a program schedule, and a channel line-up, based on the GPS position data and based on the EPG data.

20. The method of claim 16 wherein the digital television signal includes at least one of: a digital broadcast video handheld signal and a digital media broadcasting signal.
